(19) United States
(12) Patent Application Publication
(10) Pub. No.: US 2012/0287234 A1
(43) Pub. Date: Nov. 15, 2012

(54) METHOD AND APPARATUS FOR PROCESSING IMAGE SIGNALS FOR A TELEVISION

(76) Inventor: Jaekyun KIM, Seoul (KR)

(21) Appl. No.: 13/350,196

(22) Filed: Jan. 13, 2012

(30) Foreign Application Priority Data
May 11, 2011 (KR) 10-2011-0044260

(51) Int. Cl. H04N 13/02

(52) U.S. Cl. 348/43; 348/E13.026

(57) ABSTRACT

A television includes a converter to convert a first type of signal to a second type of signal and a controller to determine whether to control the converter to convert a broadcast signal from a first type of signal to a second type of signal after receipt of a channel change request. The first type of signal is one of a two-dimensional (2D) signal or a three-dimensional (3D) signal and the second type of signal is the other of the 2D signal or the 3D signal.

### CROSS-REFERENCE TO RELATED APPLICATIONS

This application claims the benefit of Korean Application No. 10-2011-0044260, filed on May 11, 2011, the contents of which are incorporated by reference.

### BACKGROUND

1. Field

One or more embodiments relate to processing signals for display.

2. Background

Improvements in televisions, monitors and other types of display devices continue to be made in order to meet consumer demand. Recently, systems for displaying three-dimensional (3D) images have gained popularity because of their ability to provide an enhanced viewing experience. The technology, however, is in many respects still new and improvements are needed.

### BRIEF DESCRIPTION OF THE DRAWING

FIG. 1 shows an embodiment of an image display device.

FIG. 2 shows an example of a control unit in the device in FIG. 1.

FIG. 3 shows an embodiment of a method for processing an image signal.

FIGS. 4 to 7 show screens generated by a first embodiment of a method for controlling output of a 3D image.

FIG. 8 shows a screen generated by a second embodiment of a method for controlling output of a 3D image.

FIGS. 9 to 15 show screens generated by a third embodiment of a method for controlling output of a 3D image.

FIG. 16 shows screens generated by another embodiment of a method for controlling output of a 3D image.

FIG. 17 shows a screen generated by another embodiment of a method for controlling output of a 3D image.

FIGS. 18 to 23 show screens generated by another embodiment of a method for controlling output of a 3D image.

FIG. 24 shows a screen generated by another embodiment of a method for controlling output of a 3D image.

FIG. 25 shows operations included in one embodiment of a method for processing an image signal.

FIGS. 26 to 29 show screens generated by an embodiment of a method for controlling output of a 2D image.

### DETAILED DESCRIPTION

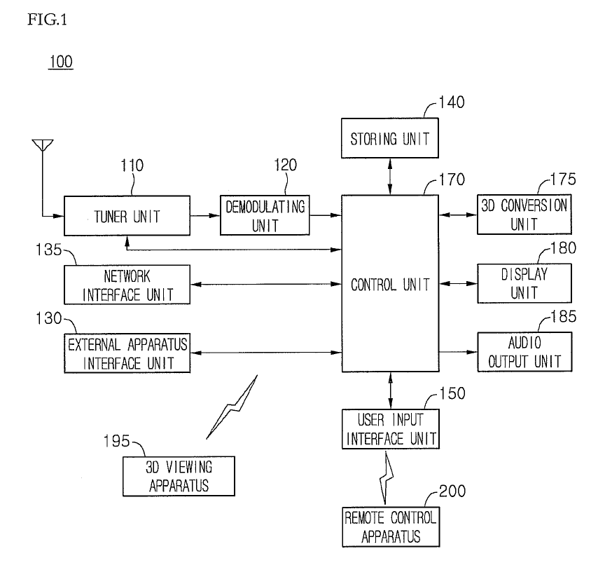

FIG. 1 shows one embodiment of an image display device 100 including a tuner unit 110, a demodulating unit 120, an external apparatus interface unit 130, a network interface unit 135, a storing unit 140, a user input interface unit 150, a control unit 170, a 3D conversion unit 175, a display unit 180, an audio output unit 185, and a 3D watching apparatus 195.

The tuner unit 110 selects a radio frequency (RF) broadcasting signal corresponding to a channel selected by the user or one or more previously stored channels among RF signals received through an antenna. The selected RF signal is converted into an intermediate frequency signal or a base band image or a voice signal.

The demodulating unit 120 receives and demodulates a digital IF signal (DIF) converted in the tuner unit 110 and may output a stream signal (TS) to the control unit 170 after the demodulation and the channel decoding.

Meanwhile, the control unit 170 outputs the image to the display unit 180 and outputs the voice to the audio output unit 185 after demultiplexing the inputted stream signal (TS) and processing image and voice signals.

The external apparatus interface unit 130 may transmit and receive a data to/from a connected external apparatus 190 and for this, may include an A/V input output unit (not shown) or a wireless communicating unit (not shown). Meanwhile, the external apparatus interface unit 130 may transmit and receive the data to/from the 3D watching apparatus such as glasses for 3D and the like.

The network interface 135 provides an interface for connecting the image display device 100 with a wired/wireless network including an internet network. The network interface may provide an Ethernet terminal to connect the wired network and may use, for example, a WLAN (Wireless LAN)(Wi-Fi), a Wibro (Wireless broadband), a Wimax (World Interoperability for Microwave Access), or a HSDPA (High Speed Downlink Packet Access) communication protocol to connect the wireless network.

The storing unit 140 may store a program for processing and controlling each signal in the control unit 170 and may store the processed image, voice, or data signal.

For example, the storing unit 140 may perform a function for temporarily storing the image, voice, or data signal inputted into the external apparatus interface unit 130 and may store information on broadcasting channels through a channel memory function of a channel map and the like.

The user input interface unit 150 transfers a signal inputted by the user to the control unit 170 or transfers a signal from the control unit 170 to the user. For example, the user input interface unit 150 may receive the user inputting signal such as a power on/off, a channel selection, a screen setting, and the like from a remote control apparatus 200, or may transmit the signal from the control unit 170 to the remote control apparatus 200.

The control unit 170 demultiplexes the stream inputted through the tuner unit 110, the demodulating unit 120, or the external apparatus interface unit 130, or processes the demultiplexed signals to generate and output the signal for outputting the image or the voice.

The image signal processed in control unit 170 is inputted into the display unit 180 to display the image corresponding to the corresponding image signal. In addition, the image signal processed in control unit 170 may be inputted into an external output apparatus through the external apparatus interface unit 130.

The voice signal processed in the control unit 170 may be outputted to the audio output unit 185. In addition, the voice signal processed in the control unit 170 may be inputted into the external output apparatus through the external apparatus interface unit 130.

In addition, the control unit 170 may control overall operations in the image display device 100. For example, the control unit 170 may control the tuner unit 110 so that the signal of the channel selected according to a received predetermined channel selection command is inputted through the user input interface unit 150 and may process the image, voice, or data signal of the selected channel.

In more detail, the control unit 170 may control the display unit 180 so as to display the image and for this, may process a broadcasting image inputted through the tuner unit 110, an external input image inputted through the external apparatus interface unit 130, an image inputted through the network interface unit 135, or an image stored in the storing unit 140 to provide the processed image to the display unit 180. In this case, the image displayed on the display unit 180 may be a still image or a moving image and may be a 2-dimensional image or a 3-dimensional image.

Meanwhile, the display unit 180 generates driving signals by converting the image signal, the data signal, an OSD signal, and control signal processed in the control unit 170 or the image signal, the data signal, and control signal received in the external apparatus interface unit 130. The display unit 180 may be, for example, a PDP, LCD, OLED, or flexible display, and according to one embodiment may be a 3D display.

In order to watch the 3D image, the display unit 180 may be divided into an additional display mode and a single display mode. In the single display mode, the 3D image may be implemented by the display unit 180 without a separate additional display, for example, glasses and the like and as an example of the single display mode, various modes such as a lenticular mode, a parallax barrier mode, and the like may be applied.

In the additional display mode, the 3D image may be implemented by using an additional display other than the display unit 180 and as an example of the additional display mode, various modes such as a head mount display (HMD) type, a glasses type, and the like may be applied. In addition, the glasses type may be again divided into a passive mode such as polarization glasses type and the like and an active mode such as a shutter glasses type. Meanwhile, even the head mount display (HMD) type may be divided into a passive mode and an active mode.

According to one embodiment, in order to watch the 3D image, glasses for 3D as the additional display 195 for 3D will be centrically described. The glasses for 3D 195 may include the polarization glasses of the passive mode or the shutter glasses of the active mode and is described as a concept including even the head mount type.

Meanwhile, the display unit 180 may be configured by a touch screen to be used as an input apparatus other than an output apparatus.

According to one embodiment, the image display device 100 may convert the 2D image signal of the broadcasting channel received through the tuner unit 110 into the 3D image signal and may output the converted 3D image signal. To accomplish this operation, 3D conversion unit 175 is included.

A method of generating or acquiring the 3D image signal may be based on use of a pair of left and right cameras when the image is acquired. The method can display a natural 3D image, but needs two cameras for acquiring the image and may have difficulty in filmizating and decoding of the acquired left and right images and a difference in frame rate of the left and right images

In another method of generating the 3D image signal, the 2D image signal acquired by one camera may be converted into the 3D image signal. The 3D conversion unit converts the 2D image signal of the broadcasting channel received through the tuner unit 110 into the 3D image signal and outputs the converted 3D image signal so that the image of the broadcasting channel is displayed by the 3D image through the display unit.

For example, the 3D conversion unit 175 processes a predetermined signal for the 2D image signal of the received current broadcasting channel to generate the 3D image, that is, the left and right images, and the generated 3D image is processed through the control unit 140 and thereafter, may be inputted to the display unit 180.

As an example for a method of converting the 2D image signal into the 3D image signal by the 3D conversion unit 175, a modified time difference (MTD) mechanism may be used. According to the MTD mechanism, the 3D conversion unit 175 may use any one image selected among images of a plurality of previous frames as a frame making a pair with a current image of the 2D image signal. The previous image selected as the frame making a pair with the current image is referred to as a delayed image, and whether or not to select the image of any frame as the current image and whether the current image is the left image or the right image may vary according to a speed and a direction of movement. According to one embodiment, the 3D conversion unit 175 may convert the image of the broadcasting channel received through the tuner unit 110 into the 3D image signal.

Further, the 3D conversion unit 175 may convert the 2D image signal, which is stored in the storing unit 140 or inputted through the external apparatus interface unit 130 or the network interface unit 130, into the 3D image signal to output the converted 3D image signal. In addition, the 3D conversion unit 175 may perform a reverse process of the conversion operation as described above to convert and output the 3D image signal received through the tuner unit 110 into the 2D image signal.

The audio output unit 185 receives a signal processed with the voice in the control unit 170, for example, a stereo signal, a 3.1 channel signal, or 5.1, 6.1 or 7.1 channel signal to output the processed signal to the voice. The voice output unit 185 may be implemented with various types of speakers.

The remote control apparatus 200 transmits the user input to the user input interface unit 150 and for this, may use, for example, Bluetooth, RF (Radio Frequency) communication, infrared (IR) communication, a UWB (Ultra Wideband), or a ZigBee system. In addition, the remote control apparatus 200 receives the image, voice, or data signal outputted from the user input interface unit 150 to display and voice output the signal in the remote control apparatus 200.

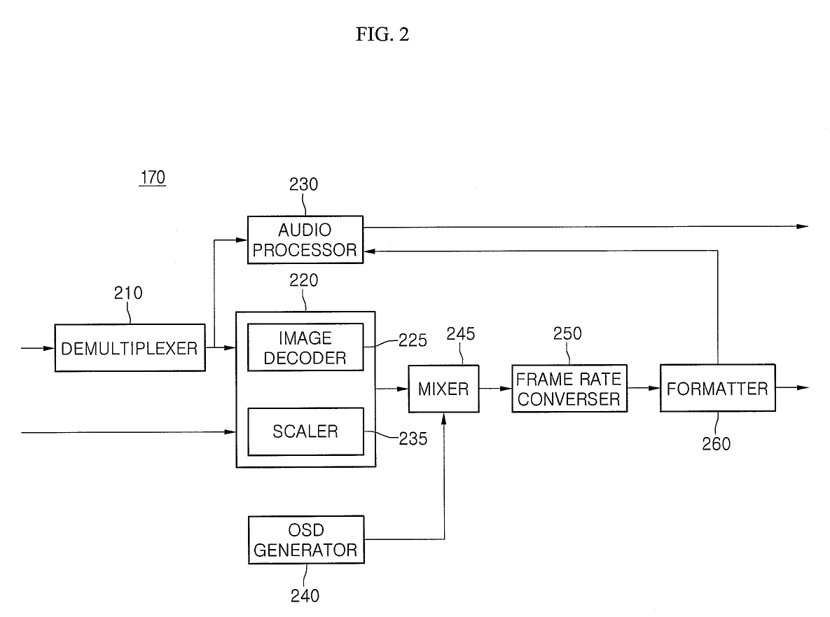

FIG. 2 shows an example of how control unit 170 shown in FIG. 1 may be configured. As shown, control unit 170 may include a demultiplexer 210, an image processor 220, an audio processor 230, an OSD generator 240, a mixer 245, a frame rate converser 250, and a formatter 260.

The demultiplexer 210 demultiplexes an inputted stream and for example, in the case where an MPEG-2 TS is inputted, the MPEG-2 TS is demultiplexed to be divided into each of the image, voice, and data signals.

The image processor 220 processes the image of the demultiplexed image signal and for this, may include an image decoder 225 and a scaler 235.

The image decoder 225 decodes the demultiplexed image signal and the scaler 235 scales the decoded image signal at an outputtable resolution in the display unit 180. Further, the image decoder 225 may include a 3D image decoder (not shown) for decoding the 3D image signal and the demultiplexed image signal inputted to the 3D image decoder (not shown) may be an image signal coded by using an MVC (Multi-watch Video Coding) or a dual AVC or a mixed signal of each of a coded left image signal and right image signal.

For example, the image signal of the broadcasting channel received through the tuner unit 110 may be a 2D image signal, a 3D image signal, or a mixed signal of the 2D image signal and the 3D image signal and the control unit 170 having the configuration as shown in FIG. 2 processes the broadcasting signal according to a kind of the image signal and thereafter, may output the processed broadcasting signal to the 3D conversion unit 175, the display unit 180, the audio output unit 185, and the like.

The audio processor 230 may performed the voice processing of the demultiplexed voice signal.

The OSD generator 240 generates an OSD signal according to the user input or in itself. For example, based on the user input signal, may generate a signal for display various kinds of information with a graphic or a text on the screen of the display unit 180.

The mixer 245 may mix the OSD signal generated in the OSD generator 240 and the decoded image signal processed in the image processor 220. In this case, the OSD signal and the decoded image signal may include at least one of the 2D image signal and the 3D image signal and the mixed image signal may be provided to the frame rate converser 250.

The frame rate converter (FRC) 250 converts frame rate of the inputted image and for example, may convert the frame rate of 60 Hz into the frame rate of 120 Hz or 240 Hz.

The formatter 260 may divide the signal mixed in mixer 245 into the 2D image signal and the 3D image signal and may change the format of the 3D image signal.

According to one embodiment, when the 2D image signal of the broadcasting channel is converted into a 3D image signal and output according to a user selection or a setting of the image display device 100, the 3D conversion unit 175 receives the decoded 2D image signal through the image decoder 220 to convert the decoded 2D image signal into the 3D image signal and thereafter, may again output the converted 3D image signal to the control unit 170.

The control unit 170 may output the 3D image signal inputted from the 3D conversion unit 175 to the display unit 180 by performing the image processing processes as described with reference to FIG. 2.

According to another embodiment, as shown in FIG. 1, the 3D conversion unit 175 is not provided separately at the outside of the control unit 170 and the formatter 260 in the control unit 170 may act to convert the 2D image signal into the 3D image signal.

Further, the control unit 170 may include a data processor (not shown) for processing a broadcasting information data such as electronic program guide (EPG) information and the like. For example, the EPG information may be ATSC-PSIP (ATSC-Program and System Information Protocol) information in the case of an ATSC system and may be DVB-SI (DVB-Service Information) information in the case of a DVB system.

Meanwhile, the configurations of the image display device 100 and the control unit 170 shown in FIGS. 1 and 2 are just exemplary embodiments. Other embodiments are possible. For example, some of the configurations of the control unit 170 shown in FIG. 2 may be integrated, added, or omitted and a processing order of each of the configurations may be changed.

According to one embodiment, the user may set whether or not to continuously perform the 2D/3D conversion when the broadcasting channel is changed, while the image display device 100 performs the 2D/3D conversion for converting the 2D image signal into the 3D image signal or the 3D image signal into the 2D image signal. The converted signal may then be displayed as the image signal of the broadcasting channel watched by the user.

For example, the control unit 170 may determine whether or not to convert the 2D image signal received through the second broadcasting channel into a 3D image for output, when the receiving channel is changed to the second broadcasting channel. This may occur, for example, while the 2D image signal of the first broadcasting channel is converted into the 3D image signal for output by the 3D conversion unit 175 provided in the image display device 100.

On the other hand, the control unit 170 may determine whether or not to convert the 3D image signal received through the second broadcasting channel into the 2D image for output, when the receiving channel is changed to the second broadcasting channel, This may occur, for example, while the 3D image signal of the first broadcasting channel is converted into the 2D image signal for output by the 3D conversion unit 175 provided in the image display device 100.

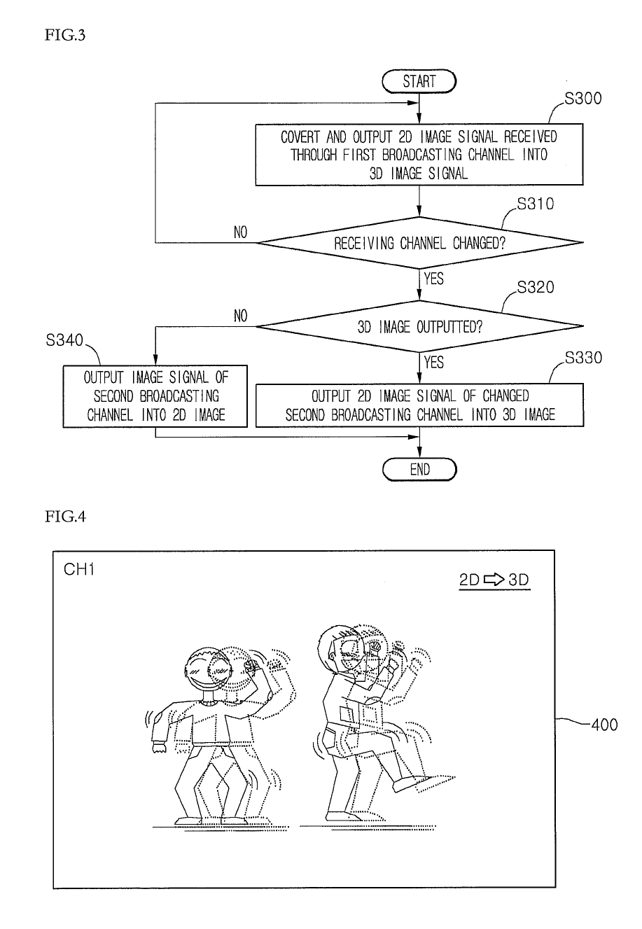

A method of processing a broadcasting signal according to one embodiment will now be described in more detail with reference to FIGS. 3 to 24.

FIG. 3 shows a flowchart of one embodiment of a method for processing a broadcasting signal in association with image display device 100. Referring to FIG. 3, the 3D conversion unit 175 of image display device 100 converts the 2D image signal received through the first broadcasting channel into the 3D image signal for output (S300). For example, the tuner unit 110 receives the broadcasting signal of the first broadcasting channel selected by the user and the signal of the first broadcasting channel may be inputted into the control unit 170 through the demodulating unit 120.

The control unit 170 decodes the image signal among the signals of the first broadcasting channel and then, transfers the image signal to the 3D conversion unit 175. The 3D conversion unit 175 converts the 2D image signal of the first broadcasting channel into the 3D image signal according to the same conversion mechanism as described above to output the converted 3D image signal to the control unit 170.

Meanwhile, the control unit 170 performs the image processing operations as described with reference to FIGS. 1 and 2 for the 3D image signal inputted from the 3D conversion unit 175 and thereafter, transfers the processed 3D image signal to the display unit 180, such that the control unit 170 may control the image of the first broadcasting channel to be displayed by the 3D image in the display unit 180.

The control unit 170 checks whether or not a receiving channel is converted (S310) and when the receiving channel is changed to the second broadcasting channel, the control unit 170 determines whether or not to convert the image of the second broadcasting channel into the 3D image (S320).

For example, while the user watches the image of the first broadcasting channel converted into the 3D image, the user can change the receiving channel into the second broadcasting channel. During the conversion of the receiving channel, the control unit 170 may determine whether or not to continuously convert and output the image of the converted second broadcasting channel into the 3D image.

The control unit 170 may determine whether or not to output the image of the changed second broadcasting channel into the 3D image according to the user setting. The user setting relating to output of the 3D image or not may be a predetermined value received from the user in the conversion of the receiving channel or may be one that was previously input by the user.

Exemplary embodiments of the method for determining whether the control unit 170 is to output the image of the changed second broadcasting channel into the 3D image will now be described in detail with reference to FIGS. 5 to 24.

When the receiving channel is not changed, the control unit 170 may control the 3D conversion unit 175 and the display unit 180 so that the image of the first broadcasting channel is converted into the 3D image signal for output.

When determining that the image of the first broadcasting channel is to be output as a 3D image, the control unit 170 controls the 3D conversion unit 175 so as to convert and output the 2D image signal of the changed second broadcasting channel into the 3D image (S330).

When determining that the image of the second broadcasting channel is to be output into the 2D image, the control unit 170 processes the image of the second broadcasting channel to output the processed image to the 2D image (S340).

A first exemplary embodiment for a method of setting whether or not to output a 3D image in the change of a receiving channel will be described with reference to FIGS. 4 to 7. As shown in FIG. 4, the receiving channel may be changed from the “CH1” to a “CH2” by the user input, while converting the 2D image signal of a “CH1” into the 3D image signal and displaying the converted 3D image signal on the screen 400 of the image display device 100.

Referring to FIG. 5, in response to the receiving channel change from the “CH1” to the “CH2”, a popup window 410 for selecting whether or not to output the 3D image by the user may be displayed on the screen 400 of the image display device 100.

That is, when the user changes the receiving channel by using a channel up/down button (not shown) or a channel number input button (not shown), the popup window 410 for checking whether or not to continuously watch the changed image of the changed “CH2” into the 3D image (that is, whether or not to continuously perform the 2D/3D conversion for converting the 2D image signal into the 3D image signal) is displayed on the screen 400 and the user selects an “yes” button 411 or a “no” button 412 included in the popup window 410 to determine whether or not to output the 3D image.

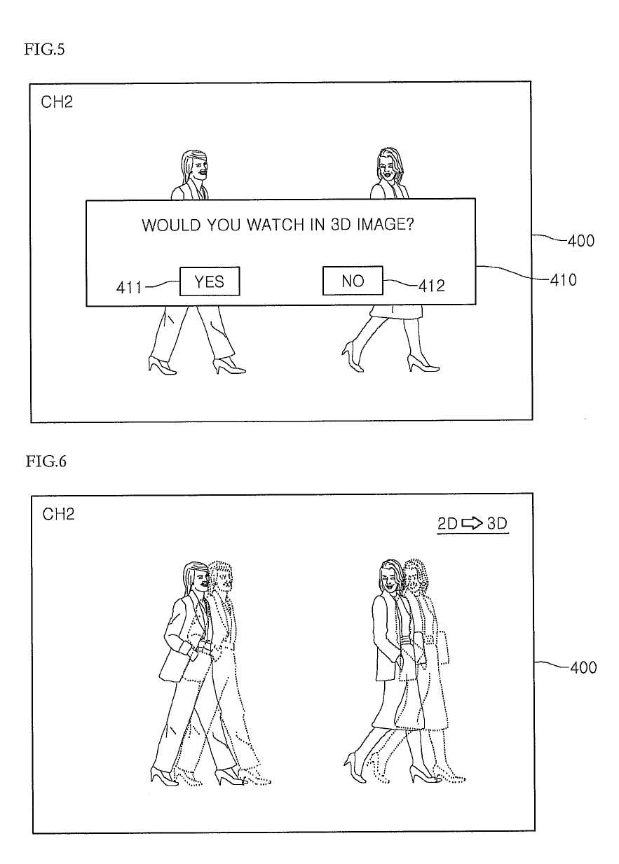

For example, when the user checks the popup window 410 and presses a “check” button (alternately, any one button corresponding to the “yes” button 411) in the remote control apparatus 200, the 2D image signal of the changed “CH2” is converted into the 3D image signal to be displayed on the screen 400, as shown in FIG. 6.

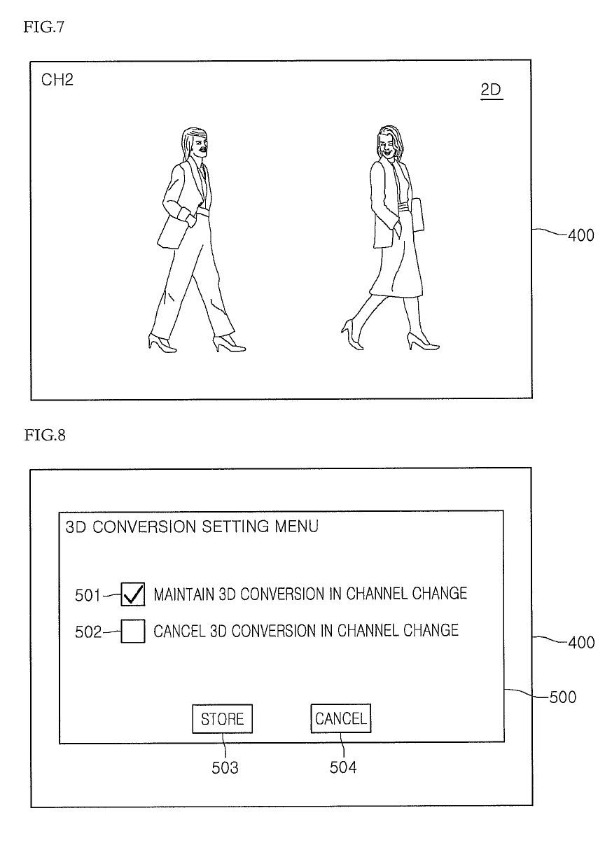

When the user presses a “cancel” button (alternately, any one button corresponding to the “no” button 412) in the remote control apparatus 200, the conversion from the 2D image signal to the 3D image signal is terminated and the image of the “CH2” may be displayed to the 2D image on the screen 400, as shown in FIG. 7.

According to the exemplary embodiment of FIGS. 4 to 7, the control unit 170 may determine whether or not to convert the image signal received from the changed broadcasting channel (for example, the “CH2”) into the 3D image signal for output according to the input from the user when the receiving channel is changed.

Referring to FIG. 8, a second embodiment for setting whether or not to output the 3D image when the channel is changed involves displaying a menu item for setting the output of the 3D image or not, when the change of the receiving channel is changed. For example, a 3D conversion setting menu window 500 may be displayed on the screen 400 to allow the user to set whether or not to maintain conversion into the 3D image signal in an OSD (On Screen Display) type in the change of the receiving channel.

After the user requests the display of the 3D conversion setting menu window 500 as shown in FIG. 8, the user selects any one of check boxes 501 and 502 included in the 3D conversion setting menu window 500 to set whether to maintain or cancel the 3D conversion in the channel change.

When the user selects a first check box 501 for setting the “maintain of the 3D conversion in the channel change” in the 3D conversion setting menu window 500 and then, selects a store button 503, the conversion into the 3D image signal may be maintained in a subsequent change of the receiving channel.

In this case, as shown in FIG. 6, when the receiving channel is changed from the “CH1” to the “CH2,” a separate popup window 410 is not displayed and the image of the “CH2” is converted into the 3D image signal according to a predetermined user setting using the 3D conversion setting menu window 500 to be displayed on the screen 400.

When the user selects a second check box 502 for setting the “cancel of the 3D conversion in the channel change” in the 3D conversion setting menu window 500 and then, selects a store button 503, the conversion into the 3D image signal may be cancelled in a subsequent conversion of the receiving channel.

In this case, as shown in FIG. 7, when the receiving channel is changed from the “CH1” to the “CH2”, the image signal of the “CH2” is not converted into the 3D image signal to be displayed into the 2D image on the screen 400.

According to another embodiment, the 3D conversion setting menu may be provided to allow the user to set whether to maintain or cancel the 3D conversion in the channel change for each of plural items.

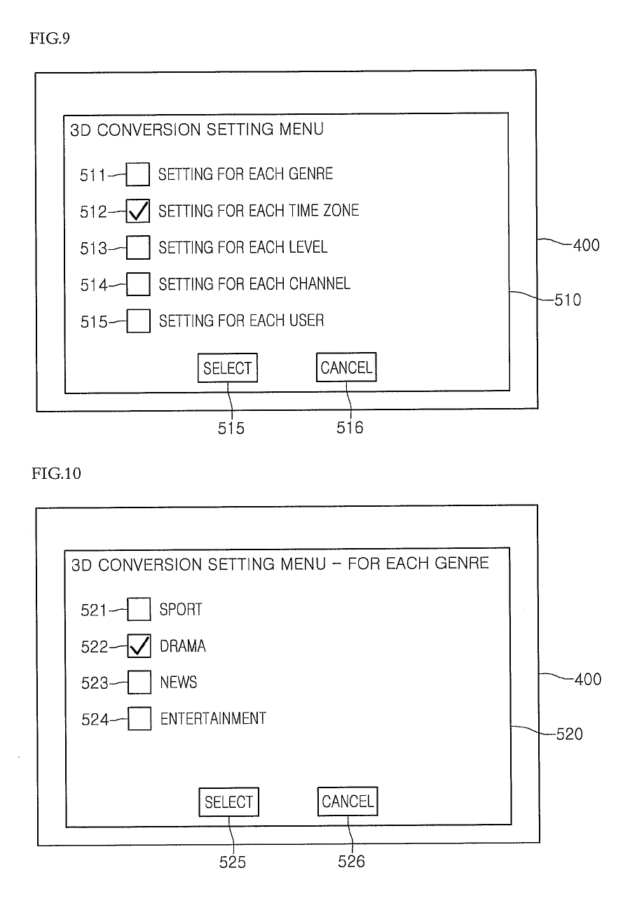

Referring to FIG. 9, the user may set whether or not to maintain the 3D conversion by using the 3D conversion setting menu 510 displayed on the screen 400. This menu allows a user to control a 3D setting based on one or more of a genre of broadcasting image, watching time or time zone, watching or parental level, channel, and each user. That is, the user may set whether or not to maintain the 3D conversion in the channel change for a predetermined menu item by selecting any one or more of a plurality of check boxes 511 to 515 included in the 3D conversion setting menu 510.

For example, when the user checks the check box 511 for the “setting for each genre” in the 3D conversion setting menu 510 and then selects a “select” button 505, a menu 520 capable of setting whether or not to maintain the 3D conversion for one or more of a plurality of genres may be displayed on the screen 400.

For example, when a user checks box 522 corresponding to the “drama” genre and then selects the “select” button 525 as shown in FIG. 10, menu 530 capable of setting whether or not to maintain 3D conversion may be displayed on the screen 400 in the channel change for the “drama” genre.

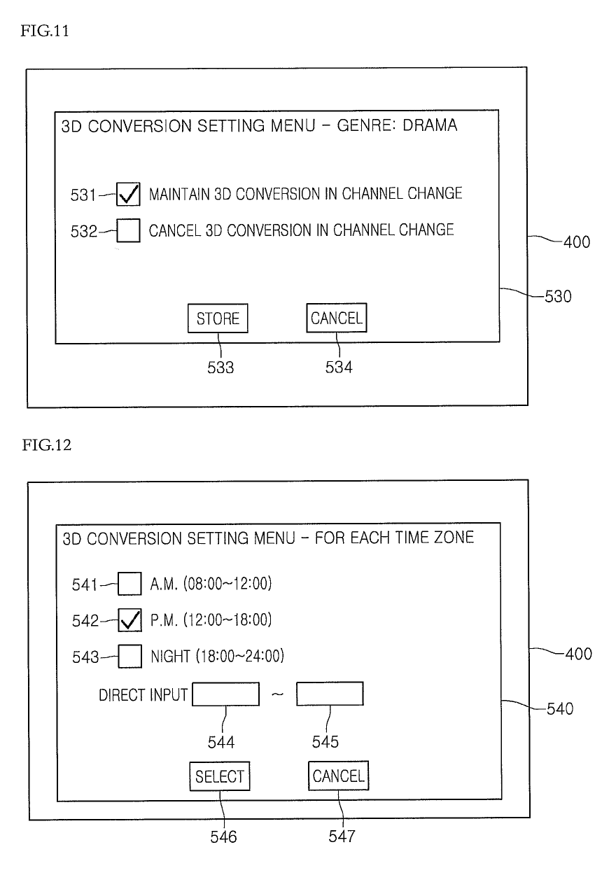

On the menu shown in FIG. 11, when the user selects the check box 531 for setting the “maintain of the 3D conversion in the channel change” and then selects the store button 533, conversion into the 3D image signal performed in the previous channel may be continuously maintained in the changed channel in which the program corresponding to the “drama” genre is broadcasted.

For example, as shown in FIG. 6, when the broadcasting program corresponding to “drama” is received from the changed “CH2”, the image of the “CH2” is converted into the 3D image signal according to the user setting for each genre to be displayed on the screen 400.

When the user selects the check box 532 for setting the “cancel of the 3D conversion in the channel change” for the “drama” and then selects store button 533, the 3D image conversion performed in the previous channel may be cancelled in the changed channel in which the program corresponding to the “drama” genre is broadcasted.

In this case, as shown in FIG. 7, when the receiving channel is changed from the “CH1” to the “CH2” in which the “drama” program is broadcasted,” the image of the “CH2” is not converted into the 3D image signal according to the user setting for each genre to be displayed to the 2D image on the screen 400.

The genre information of the broadcasting channel may be acquired, for example, based on electronic program guide (EPG) information received together with the broadcasting signal through the tuner unit 110.

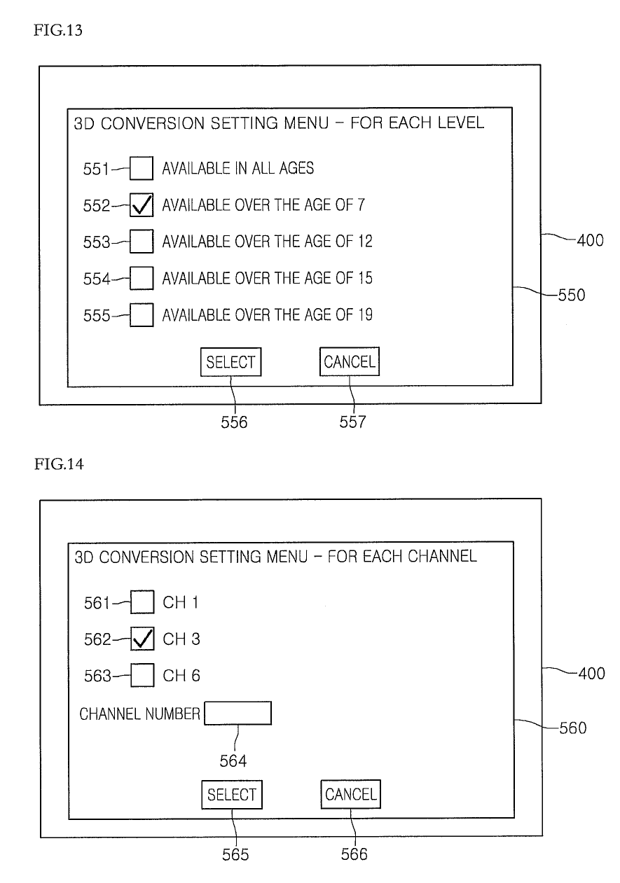

Further, on the 3D conversion setting menu 510 as shown in FIG. 9, when the user selects the check box 512 for the “setting for each time” and then selects the “select” button 515 as shown in FIG. 12, the menu 540 capable of setting whether or not to maintain the 3D conversion may be displayed on the screen 400 based on a time at which the program is broadcasted.

Thereafter, for example, when a user checks box 542 corresponding to a time range of “P.M. 12:00˜18:00” and selects the “select” button 546, a menu capable of setting whether or not to maintain the 3D conversion when the channel is changed may be displayed on the screen 400 for the selected time range.

Additionally, or alternatively, a user may directly input the time or time range for setting whether or not to maintain the 3D conversion when the channel is changed using direct input windows 544 and 545 displayed in the setting menu 540. Additionally, or alternatively, a user may set whether or not to maintain 3D conversion for the time that corresponds to the start of a predetermined program to the end of the program using the setting menu for each time.

Referring to FIG. 13, the user may set whether or not to maintain the 3D conversion of a received broadcast program for one or more of a plurality of age watching or parental levels. For example, when the user checks box 552 corresponding to a “available over the age of 7” level on the 3D conversion setting menu 550 for each level shown in FIG. 13 and selects the “select” button 556, the user may set whether or not to maintain the 3D conversion when the channel is changed for the broadcasting program corresponding to the “available over the age of 7” level.

In other embodiment, a user may set the MPAA or television rating of a program concerning whether a conversion is to be performed. The watching or parental level information of a broadcasting program may be acquired based on, for example, EPG information received together with the broadcasting signal through tuner unit 110.

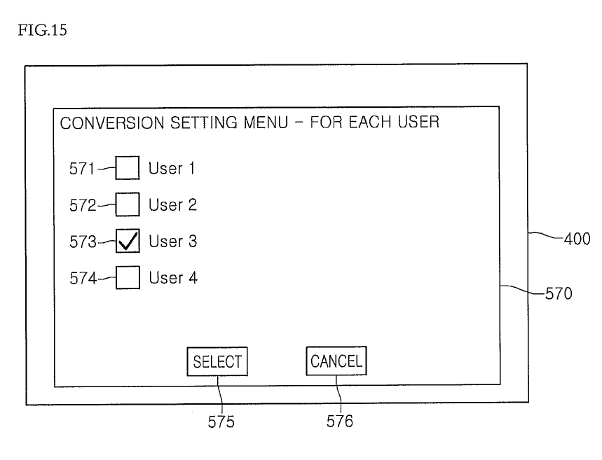

Referring to FIG. 14, a 3D conversion setting menu 560 may include an option to allow a user to set one or more channels concerning whether or not to maintain a 3D conversion. In one exemplary application, on the 3D conversion setting menu 560 for each channel, so-called favorite channels registered by the user in advance may be displayed and the user may set whether or not to maintain 3D conversion when a channel is changed for the changed channel by selecting any one of the favorite channels.

For example, when the user checks a check box 562 corresponding to a “CH3” on the menu 560 shown in FIG. 14 and selects the “select” button 566, the user may set whether or not to continuously maintain the 3D conversion performed in the previous channel in the receiving channel change to the “CH3”. Additionally, or alternatively, a menu may be presented to allow a user to set non-favorite channels or both favorite or non-favorite channels concerning whether a 3D conversion is to be performed based on a channel change operation.

When the user checks the check box 515 for the “setting for each user” on the 3D conversion setting menu 510 shown in FIG. 9 and then selects the “select” button 515, a menu 570 capable of setting whether or not to maintain the 3D conversion for one or more users may be displayed on the screen 400 as shown in FIG. 15.

More specifically, information for pre-registered users in the image display device 100 may be displayed on the 3D conversion setting menu 570 for each user and the user may select any one or more of the registered users to set whether or not to maintain the 3D conversion when the channel is changed for the corresponding user. For example, when the user checks a check box 573 corresponding to a “User 3” and selects the “select” button 575, the user may set whether or not to maintain the 3D conversion for a channel change in the case where User 3 uses the image display device 100.

A method of recognizing the user who is currently using the image display device 100 (e.g., a television) may be performed based on user log-in information entered into the image display device 100 and/or through a camera and face recognition software stored in a storage device within or coupled to the display device.

For example, when the setting for maintaining 3D conversion when the channel is changed has been selected for User 3, based on 3D conversion setting menu 570 as shown FIG. 15, and when this user is logged in, a 3D conversion is continuously performed for the program on the changed channel when the channel is changed in the image display device 100.

According to one embodiment, only when the holding time for a predetermined channel in the channel change is equal to or more than a predetermined reference value t, the process of determining whether or not to output the 3D conversion may be performed as the step S320 of FIG. 3.

That is, the control unit 170 counts a time period from when the receiving channel is changed from a first broadcasting channel to a second broadcasting channel and when the holding time for the second broadcasting channel is less than the reference value t, the process of determining whether or not to output the 3D conversion may be omitted.

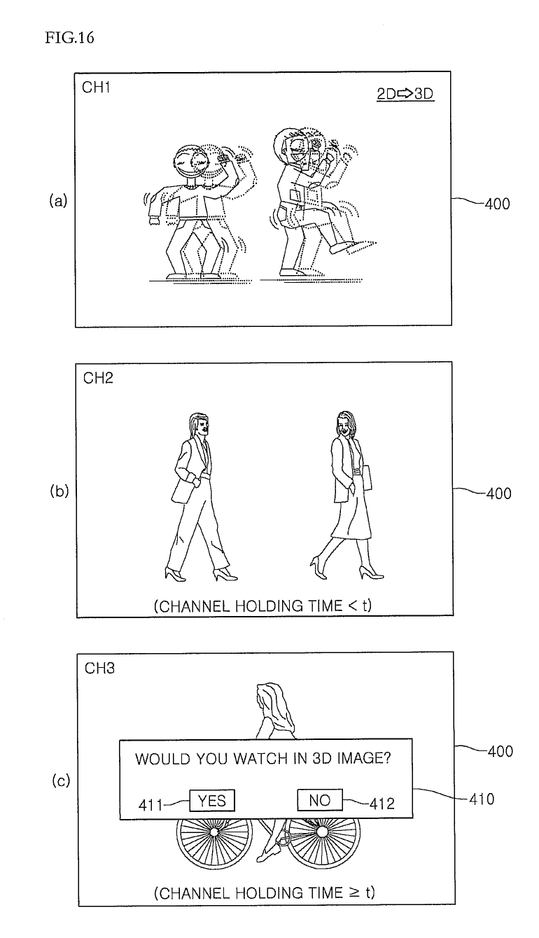

Referring to FIG. 16, when the receiving channel is changed to the “CH2” according to the user selection and thereafter is again changed to the “CH3” within the time of less than the predetermined reference value t (for example, 1 second) while the 2D image signal received through the “CH1” is converted into the 3D image signal to be displayed on the screen 400, the popup window 410 for receiving whether or not to output the 3D conversion from the user may not be displayed on the screen 400 in the change to the “CH2”.

Meanwhile, as shown in FIG. 16C, when the receiving channel is maintained by the “CH3” for the reference value t or more, the popup window 410 for receiving whether or not to output the 3D conversion from the user may be displayed on the screen 400. When the user changes the receiving channel by using the channel up/down button in the remote control apparatus 200, it is possible to prevent the popup window 410 from being unnecessarily displayed and disappeared in an unwanted intermediate channel for watching (e.g., the “CH2” shown in FIG. 16B).

Further, when the 3D image signal is provided in the changed broadcasting channel, the process of determining whether or not to output the 3D conversion may be omitted as step S320 of FIG. 3.

Referring to FIG. 17, when the receiving channel is changed to the “CH2” according to the user selection and thereafter, the broadcasting program is provided by 3D image in the “CH2” while the 2D image signal received through the “CH1” is converted into the 3D image signal to be displayed on the screen 400, the popup window 410 for receiving whether or not to output the 3D conversion from the user may not be displayed on the screen 400 in the change to the “CH2”.

That is, when the receiving channel is changed to the broadcasting channel providing the 3D image signal as a source image, the 3D conversion performed in the previous channel may be continuously maintained regardless of the user setting.

According to another embodiment, when the receiving channel is changed to a second broadcasting channel while a 2D image signal of a first broadcasting channel is converted into a 3D image signal, the image of the second broadcasting channel may be simultaneously displayed by both the 2D image and the 3D image on one screen.

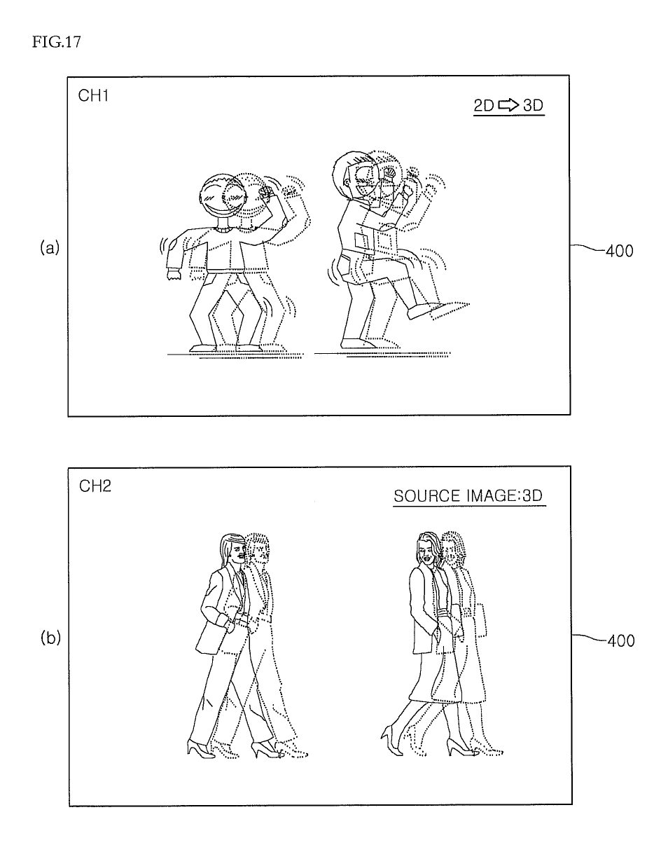

Referring to FIG. 18, when the user changes the receiving channel to the “CH2” while the 2D image signal received from the “CH1” is converted into the 3D image signal to be displayed on the screen 400, the image of “CH2” may be simultaneously displayed by both the 2D image 401 and the 3D image 402 on screen 400. For example, the control unit 170 may control so that the image of the “CH2” is displayed by the 2D image 401 at the left region of the screen 400 and the 3D-converted 3D image 402 of the “CH2” is displayed at the left of the screen 400. The positions, sizes, or the like of the 2D image 401 and the 3D image 402 may changed, for example, based on a user or manufacturer setting.

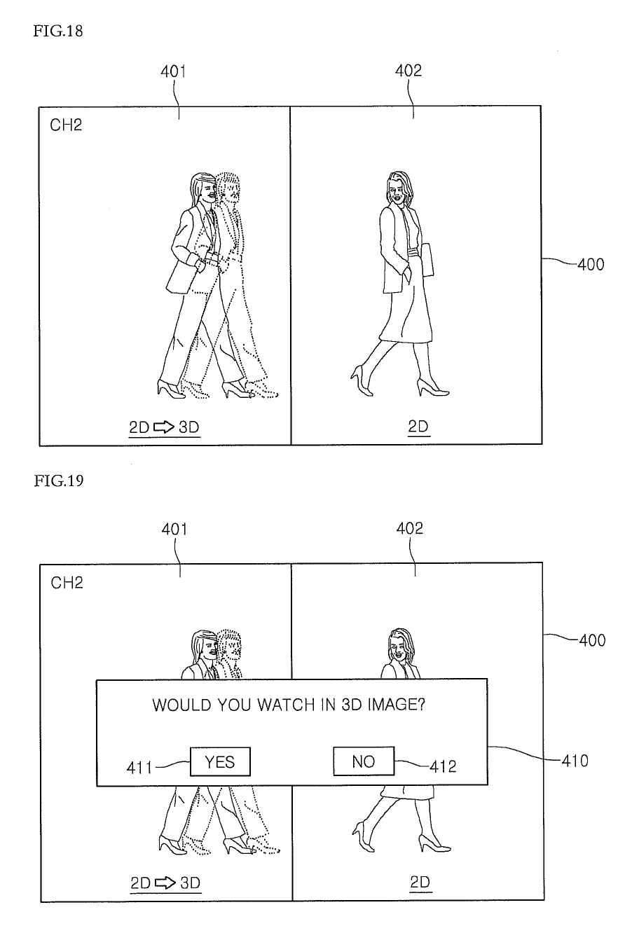

Referring to FIG. 19, popup window 410 may be displayed on screen 400 to allow the user to input whether or not to output the 3D image and the user checks the 2D image 401 and the 3D image 402 of the “CH2” as shown in FIG. 18 and then, may select whether or not to maintain the 3D conversion performed in the previous channel by using the popup window 410. That is, the user may compare image quality, colors, and/or other aspects of the 2D image 401 and the 3D image 402 of CH2 as displayed and then select the image displayed on the screen 400 according to his or her preference.

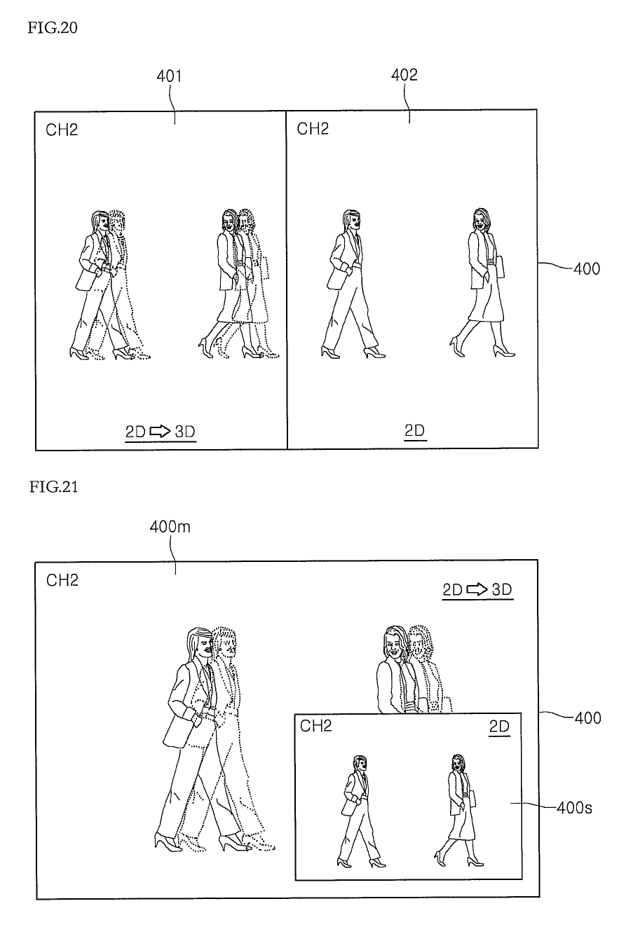

In FIG. 19, only a part of the image of the program output on CH2 is displayed in the 2D and 3D sides of the screen. In other embodiments, the full 2D and 3D images may be displayed on these respective sides to allow for improved comparison by the user. For example, as shown in FIG. 20, the entire image of the “CH2” may be displayed as a 2D image 401 on the left of the screen 400 and the entire image of “CH2” may be converted into a 3D image 402 displayed on the right of the screen 400.

Alternatively, any one of the 2D image 401 and the 3D image 402 of the “CH2” may be displayed as a main screen and the other may be displayed as a sub-screen. For example, referring to FIG. 21, 3D image 402 of CH2 may be displayed as a main screen 400m and the 2D image 401 of CH2 may be displayed as a sub-screen 400s.

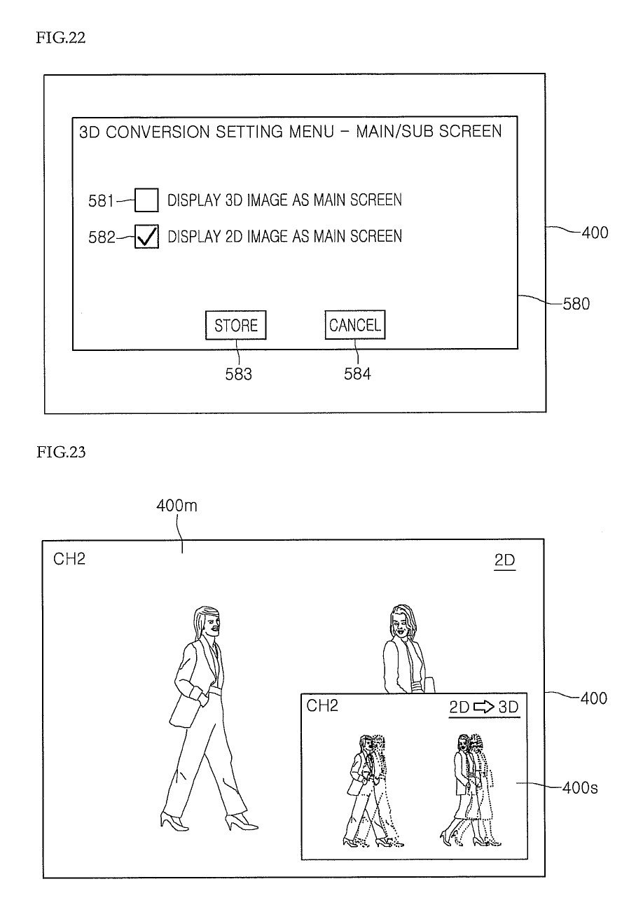

As shown in FIG. 22, in one embodiment a user may set whether to display a 2D image and a 3D image of the channel changed as a main screen using a 3D conversion setting menu 580. For example, when the user checks a box 582 for displaying the 2D image as the main screen on the menu 580 shown in FIG. 22 and then selects a “store” button 583, the 2D image of the changed “CH2” may be displayed as the main screen 400m and the 3D image of the “CH2” may be displayed as the sub-screen 400s, as shown in FIG. 23.

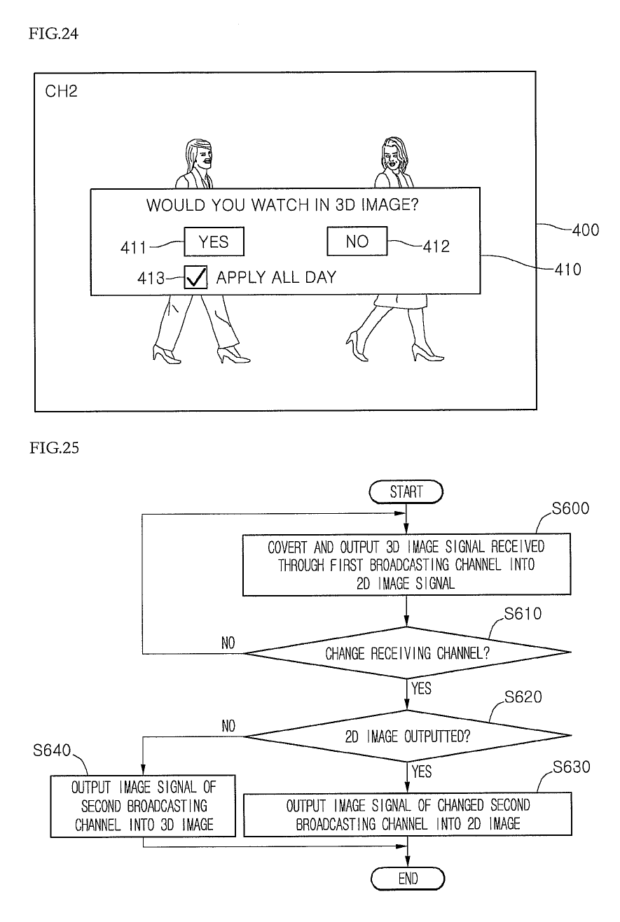

FIG. 24 shows another embodiment configured to display a popup window on a screen in the channel change. Referring to FIG. 24, in this embodiment a user may select a time period applied to the 3D conversion setting which is inputted by using the popup window 410 displayed on the screen 400 in the channel change. For example, when the user checks the check box 413 corresponded to “apply one day today” and then selects the “yes” button 411, the 3D conversion performed in the previous channel may be continuously maintained all day for channel changes.

Also, the holding time for the user setting may be set to other times or time periods (e.g., ones other than all day) such as for a one-day period on the popup menu and/or on the 3D conversion setting menu as described with reference to FIGS. 8 to 15 other than the popup window 410 shown in FIG. 24.

FIG. 25 shows a flowchart of one embodiment of a method for processing a broadcasting signal to be displayed on a display device, which, for example, may be image display device 100 or another device. According to one application, the display device may be a television or other device including or coupled to a tuner.

Referring to FIG. 25, 3D conversion unit 175 of the image display device 100 converts and outputs the 3D image signal received through the first broadcasting channel into the 2D image signal (S600). For example, the tuner unit 110 receives the broadcasting signal of the first broadcasting channel selected by the user and the signal of the first broadcasting channel may be inputted into the control unit 170 through the demodulating unit 120.

The control unit 170 decodes the image signal among the signals of the first broadcasting channel, and then transfers the image signal to 3D conversion unit 175. The 3D conversion unit converts the 3D image signal of the first broadcasting channel into the 2D image signal to output the converted 2D image signal to the control unit 170.

The control unit 170 checks whether or not a receiving channel is changed (S610) and when the receiving channel is converted into the second broadcasting channel, the control unit 170 determines whether or not to convert the image of the second broadcasting channel into the 2D image (S620).

For example, while the user watches the image of the first broadcasting channel converted into the 2D image, the user can change the receiving channel into the second broadcasting channel and in the conversion of the receiving channel, the control unit 170 may determine whether or not to continuously convert and output the image of the converted second broadcasting channel into the 2D image.

According to one embodiment, control unit 170 may determine whether or not to output the image of the changed second broadcasting channel into the 2D image by performing 2D/3D conversion the according to the user setting. The user setting related to the 2D/3D conversion or not may be a predetermined value received from the user in the conversion of the receiving channel or previously inputted from the user.

Embodiments of the method for determining whether control unit 170 outputs the image of the changed second broadcasting channel into the 2D image are the same as described with reference to FIGS. 5 to 24.

When the receiving channel is not changed, control unit 170 may control the 3D conversion unit 175 and the display unit 180 so that the image of the first broadcasting channel is converted and outputted into the 2D image signal.

When determining that the image of the first broadcasting channel is outputted into the 2D image, the control unit 170 controls the 3D conversion unit 175 so as to convert and output the 3D image signal of the changed second broadcasting channel into the 2D image (S630).

When determining that the 2D/3D conversion is not to be performed for the image of the second broadcasting channel, control unit 170 processes the image of the second broadcasting channel to output the image as a 3D image (S640).

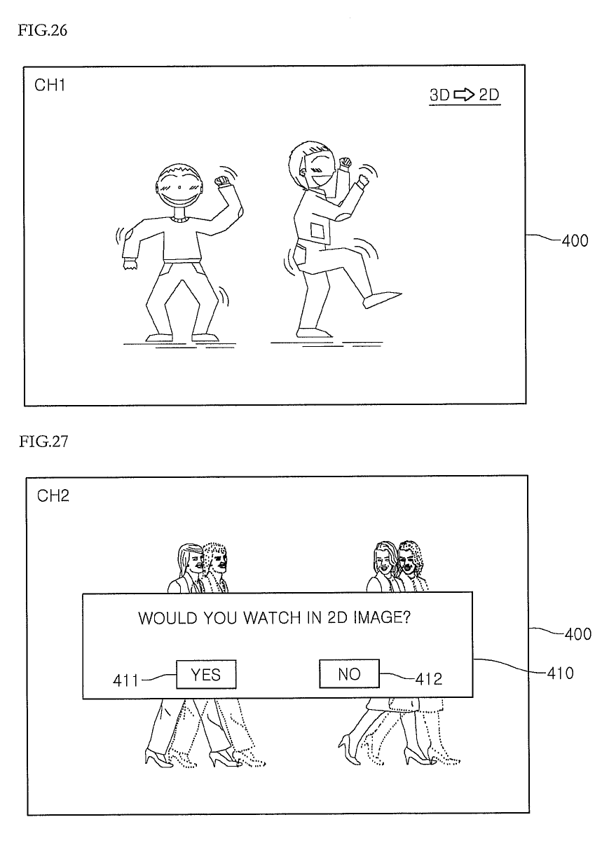

An embodiment of a method for setting whether or not to output a 2D image in the change of a receiving channel will be described with reference to FIGS. 26 to 29. As shown in FIG. 26, the receiving channel may be changed from the “CH1” to a “CH2” by the user input, while converting the 3D image signal of a “CH1” into the 2D image signal and displaying the converted 3D image signal on the screen 400 of the image display device 100.

Referring to FIG. 27, in response to the receiving channel change from the “CH1” to the “CH2”, the popup window 410 for selecting whether or not to output the 2D image by the user (that is, whether to continuously perform the 2D/3D conversion which is converted from the 3D image signal to the 2D image signal) may be displayed on the screen 400 of the image display device 100.

That is, when the user changes the receiving channel by using a channel up/down button (not shown) or a channel number input button (not shown) in the remote control apparatus 200, the popup window 410 for checking whether or not to continuously watch the image of the changed “CH2” into the 2D image is displayed on the screen 400 and the user selects an “yes” button 411 or a “no” button 412 included in the popup window 410 to determine whether or not to output the 2D image.

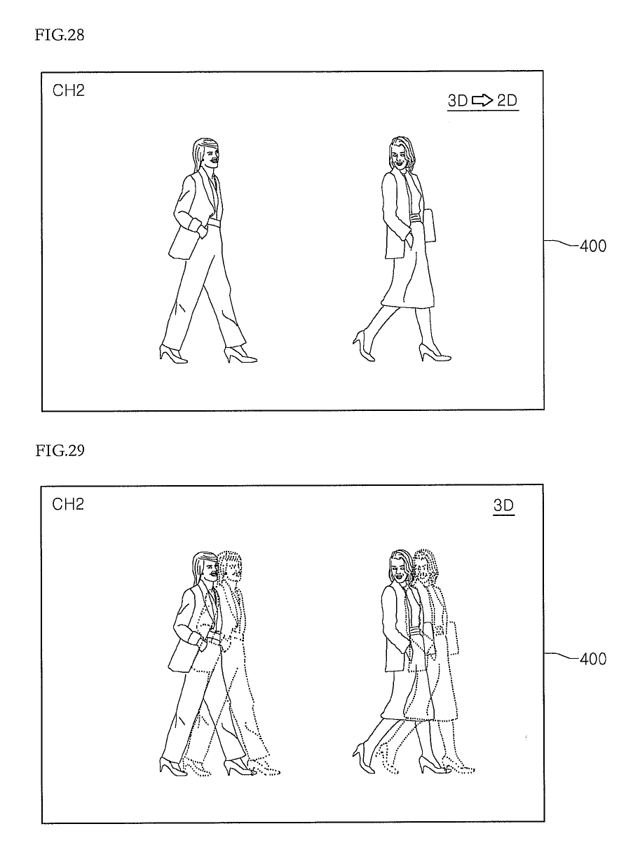

For example, when the user checks the popup window 410 and presses a “check” button (alternately, any one button corresponding to the “yes” button 411) in the remote control apparatus 200, the 3D image signal of the changed “CH2” is converted into the 2D image signal to be displayed on the screen 400, as shown in FIG. 28.

Further, when the user presses a “cancel” button (alternately, any one button corresponding to the “no” button 412) in the remote control apparatus 200, conversion from the 3D image signal to the 2D image signal is terminated and the image of the “CH2” may be displayed to the 3D image on the screen 400 as shown in FIG. 29.

In one embodiment, the case where the 2D/3D conversion is performed for the image of the broadcasting channel is described. Other embodiments may be applied to different types of signals.

For example, any of the embodiments described herein may be applied in the case where replayed content is changed according to a user selection while the 2D/3D conversion is performed for predetermined content stored in storing unit 140 of image display device 100, or is input through the external apparatus interface unit 130 or network interface unit 135 and the converted contents is replayed.

Also, a user can set whether or not to maintain 2D/3D conversion of an image signal performed in a previous channel when the broadcasting channel is changed, such that inconvenience in that the 2D/3D conversion or not should be reset every in the channel change may be reduced and use convenience of the image display device capable of displaying the 3D image can be improved.

The method of processing the broadcasting signal according to one or more embodiments described herein may be performed by a program stored in a computer-readable recording medium. Examples of the computer readable recording medium are a ROM, a RAM, a CD-ROM, a magnetic tape, a floppy disk, an optical data storing apparatus, and the like and in addition, includes the recording medium implemented in a form of carrier wave (for example, transmission through an internet).

The computer-readable recording medium is distributed in a computer system connected through the network and computer readable codes may be stored and executed by a distribution way. In addition, functional programs, codes, and code segments for implementing the method may be easily deduced by programmers.

According to one embodiment, a method of processing a broadcasting signal includes: performing a 2D/3D conversion for converting a 2D image signal into a 3D image signal or the 3D image signal into the 2D image signal to output the converted image signal for an image signal received through a first broadcasting channel; determining whether or not to continuously perform the 2D/3D conversion for the converted image signal received through a second broadcasting channel, when a receiving channel is changed from the first broadcasting channel to the second broadcasting channel; and outputting the image signal of the second broadcasting channel to the 2D image signal or the 3D image signal according to the determined result.

According to another embodiment, an image display device includes: a tuner receiving a signal of a broadcasting channel selected by a user; a conversion unit performing a 2D/3D conversion for converting a 2D image signal into a 3D image signal or the 3D image signal into the 2D image signal for an image signal received through a first broadcasting channel; and a control unit determining whether or not to continuously perform the 2D/3D conversion for an image signal received through a second broadcasting channel, when a receiving channel is changed to the second broadcasting channel while the 2D/3D conversion is performed by the conversion unit for the image signal of the first broadcasting channel.

According to another embodiment, any of the methods described herein for processing a broadcasting signal may be implemented by a computer-readable recording medium recording a program for executing the method in a computer.

According to another embodiment, an apparatus for a television comprises an on-screen display (OSD) generator; an interface to receive input to control the apparatus; a converter to convert a first type of signal to a second type of signal; and a controller to receive a request to change from a first channel to a second channel, to control the converter to convert a video signal of the second channel from the first type of signal to the second type of signal after receipt of the request and based on a command input received through the interface, and to output for display the video signal of the second channel as the first type of signal or the second type of signal, wherein the first type of signal is one of a two-dimensional (2D) signal or a three-dimensional (3D) signal and the second type of signal is the other of the 2D signal or the 3D signal.

The OSD generator may control display of at least one setting menu.

The setting menu may include a first option to automatically convert the first type of signal to the second type of signal when the channel is changed to the second channel, wherein the command input selects the first option.

The setting menu may include an option to automatically convert the first type of signal to the second type of signal when the channel is changed to the second channel and the video signal of the second channel corresponds to a predetermined type of genre.

The setting menu may include an option to automatically convert the first type of signal to the second type of signal when the channel is changed to the second channel and when the video signal of the second channel corresponds to a predetermined time.

The setting menu may include an option to automatically convert the first type of signal to the second type of signal when the channel is changed to the second channel and when the video signal of the second channel corresponds to a predetermined age level.

The setting menu may include an option to automatically convert the first type of signal to the second type of signal when the channel is changed to the second channel and when the video signal of the second channel corresponds to a predetermined rating.

The setting menu may include an option to automatically convert the first type of signal to the second type of signal when the channel is changed to the second channel and when the video signal of the second channel corresponds to a predetermined channel.

The setting menu may include an option to automatically convert the first type of signal to the second type of signal when the channel is changed to the second channel and when the video signal of the second channel corresponds to a predetermined user. The controller may determine an identity of a user based on log-in information or face recognition software.

The controller may receive a request to change from the second channel to a third channel and then causes a broadcast signal of the third channel to be output as the first type of signal, and the OSD may display a menu including a first option to cause the video signal of the third channel to be output as the second type of signal, wherein the OSD displays said menu after the video signal has been output as the first type of signal for a predetermined amount of time.

The controller may simultaneously output at least a portion of the video signal of the second channel as the first type of signal and outputs at least a portion of the video signal of the second channel as the second type of signal and may receive a signal selecting one of the first type of signal or the second type of signal, wherein the controller controls the converter to convert the video signal of the second channel into the second type of signal for output when the second type of signal is selected.

The portion of the video signal of the second channel output as the first type of signal may be different from the portion of the video signal of the second channel output as the second type of signal. Additionally, or alternatively, at least the portion of the video signal of the second channel may be output as the first type of signal in a first area of the screen and at least the portion of the video signal of the second channel may be output as the second type of signal in a second area of the screen.

In accordance with another embodiment, a method for controlling a television comprises receiving a video signal of a first channel; receiving a request to change the first channel to a second channel; determining whether to convert a video signal of the second channel from a first type of signal to a second type of signal after receiving the request, and displaying the video signal of the second channel as the first type of signal or second type of signal based on said determination, wherein conversion of the video signal is performed based on at least one setting menu generated by an on-screen display (OSD) generator and wherein the first type of signal is one of a two-dimensional (2D) signal or a three-dimensional (3D) signal and the second type of signal is the other of the 2D signal or the 3D signal.

The OSD generator may generate at least one setting menu.

The at least one setting menu may include a first option to automatically convert the first type of signal to the second type of signal when the channel is changed to the second channel, and a second option to prevent the first type of signal from being converted to the second type of signal when the channel is changed.

The at least one setting menu may include an option to automatically convert the first type of signal to the second type of signal when the channel is changed to the second channel and the video signal of the second channel corresponds to a predetermined type of genre.

The at least one setting menu may include an option to automatically convert the first type of signal to the second type of signal when the channel is changed to the second channel and the video signal of the second channel corresponds to a predetermined time.

The at least one setting menu may include an option to automatically convert the first type of signal to the second type of signal when the channel is changed to the second channel and the video signal of the second channel corresponds to a predetermined age level.

The at least one setting menu may include an option to automatically convert the first type of signal to the second type of signal when the channel is changed to the second channel and the video signal of the second channel corresponds to a predetermined rating.

The at least one setting menu may include an option to automatically convert the first type of signal to the second type of signal when the channel is changed to the second channel and the video signal of the second channel corresponds to a predetermined channel.

The at least one setting menu may include an option to automatically convert the first type of signal to the second type of signal when the channel is changed to the second channel and the video signal of the second channel corresponds to a predetermined user.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of one embodiment may be combined with the features of one or more of the other embodiments to form additional embodiments.

Although embodiments have been described with reference to a number of illustrative embodiments, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for a television comprising:
an on-screen display (OSD) generator;
an interface to receive input to control the apparatus;
a converter to convert a first type of signal to a second type of signal; and
a controller to receive a request to change from a first channel to a second channel, to control the converter to convert a video signal of the second channel from the first type of signal to the second type of signal after receipt of the request and based on a command input received through the interface, and to output for display the video signal of the second channel as the first type of signal or the second type of signal, wherein the first type of signal is one of a two-dimensional (2D) signal or a three-dimensional (3D) signal and the second type of signal is the other of the 2D signal or the 3D signal.

2. The apparatus of claim 1, wherein the OSD generator controls display of a setting menu that includes a first option to automatically convert the first type of signal to the second type of signal when the channel is changed to the second channel, wherein the command input selects the first option.

3. The apparatus of claim 1, wherein the OSD generator controls display of a setting menu that includes an option to automatically convert the first type of signal to the second type of signal when the channel is changed to the second channel and the video signal of the second channel corresponds to a predetermined type of genre.

4. The apparatus of claim 1, wherein the OSD controls display of a setting menu that includes an option to automatically convert the first type of signal to the second type of signal when the channel is changed to the second channel and when the video signal of the second channel corresponds to a predetermined time.

5. The apparatus of claim 1, wherein the OSD controls display of a setting menu that includes an option to automatically convert the first type of signal to the second type of signal when the channel is changed to the second channel and when the video signal of the second channel corresponds to a predetermined age level.

6. The apparatus of claim 1, wherein the OSD controls display of a setting menu that includes an option to automatically convert the first type of signal to the second type of signal when the channel is changed to the second channel and when the video signal of the second channel corresponds to a predetermined rating.

7. The apparatus of claim 1, wherein the OSD controls display of a setting menu that includes an option to automatically convert the first type of signal to the second type of signal when the channel is changed to the second channel and when the video signal of the second channel corresponds to a predetermined channel.

8. The apparatus of claim 1, wherein the OSD controls display of a setting menu that includes an option to automatically convert the first type of signal to the second type of signal when the channel is changed to the second channel and when the video signal of the second channel corresponds to a predetermined user.

9. The apparatus of claim 8, wherein the controller determines an identity of a user based on log-in information or face recognition software.

10. The apparatus of claim 1, wherein:
the controller receives a request to change from the second channel to a third channel and then causes a broadcast signal of the third channel to be output as the first type of signal, and
the OSD displays a menu including a first option to cause the video signal of the third channel to be output as the second type of signal, wherein the OSD displays said menu after the video signal has been output as the first type of signal for a predetermined amount of time.

11. The apparatus of claim 1, wherein the controller:
simultaneously outputs at least a portion of the video signal of the second channel as the first type of signal and outputs at least a portion of the video signal of the second channel as the second type of signal, and
receives a signal selecting one of the first type of signal or the second type of signal, wherein the controller controls the converter to convert the video signal of the second channel into the second type of signal for output when the second type of signal is selected.

12. The apparatus of claim 11, wherein the portion of the video signal of the second channel output as the first type of signal is different from the portion of the video signal of the second channel output as the second type of signal.

13. The apparatus of claim 11, wherein:
at least the portion of the video signal of the second channel is output as the first type of signal in a first area of the screen,
at least the portion of the video signal of the second channel is output as the second type of signal in a second area of the screen.

14. A method for controlling a television, comprising:
receiving a video signal of a first channel;
receiving a request to change the first channel to a second channel;
determining whether to convert a video signal of the second channel from a first type of signal to a second type of signal after receiving the request, and
displaying the video signal of the second channel as the first type of signal or second type of signal based on said determination, wherein conversion of the video signal is performed based on at least one setting menu generated by an on-screen display (OSD) generator and wherein the first type of signal is one of a two-dimensional (2D) signal or a three-dimensional (3D) signal and the second type of signal is the other of the 2D signal or the 3D signal.

15. The method of claim 14, wherein the at least one setting menu includes a first option to automatically convert the first type of signal to the second type of signal when the channel is changed to the second channel.

16. The method of claim 15, wherein the at least one setting menu includes a second option to prevent the first type of signal from being converted to the second type of signal when the channel is changed.

17. The method of claim 14, wherein the at least one setting menu includes an option to automatically convert the first type of signal to the second type of signal when the channel is changed to the second channel and the video signal of the second channel corresponds to a predetermined type of genre.

18. The method of claim 14, wherein the at least one setting menu includes an option to automatically convert the first type of signal to the second type of signal when the channel is changed to the second channel and the video signal of the second channel corresponds to a predetermined time.

19. The method of claim 14, wherein the at least one setting menu includes an option to automatically convert the first type of signal to the second type of signal when the channel is changed to the second channel and the video signal of the second channel corresponds to a predetermined age level.

20. The method of claim 14, wherein the at least one setting menu includes an option to automatically convert the first type of signal to the second type of signal when the channel is changed to the second channel and the video signal of the second channel corresponds to a predetermined rating.

21. The method of claim 14, wherein the at least one setting menu includes an option to automatically convert the first type of signal to the second type of signal when the channel is changed to the second channel and the video signal of the second channel corresponds to a predetermined channel.

22. The method of claim 14, wherein the at least one setting menu includes an option to automatically convert the first type of signal to the second type of signal when the channel is changed to the second channel and the video signal of the second channel corresponds to a predetermined user.
